(19) United States
(12) Patent Application Publication
(10) Pub. No.: US 2009/0213383 A1
(43) Pub. Date: Aug. 27, 2009

(54) APPARATUS AND METHOD FOR DETECTING ONE OR MORE SUBSTANCES

(76) Inventors: Nguyen Ly, Tempe, AZ (US); Feimeng Zhou, Temple City, CA (US); Tainwei Jing, Tempe, AZ (US); Nongjian Tao, Scottsdale, AZ (US)

Correspondence Address: BRYAN CAVE LLP, TWO NORTH CENTRAL AVENUE, SUITE 2200, PHOENIX, AZ, 85004, US

(21) Appl. No.: 12/463,331

(22) Filed: May 8, 2009

Related U.S. Application Data
(63) Continuation-in-part of application No. 11/544,796, filed on Oct. 6, 2006.
(60) Provisional application No. 61/051,655, filed on May 8, 2008.

(51) Int. Cl. G01N 21/55

(52) U.S. Cl. 356/445

(57) ABSTRACT

Several embodiments of a method of detecting a substance are disclosed herein.

### CROSS-REFERENCE TO RELATED APPLICATIONS

This application is a continuation-in-part of U.S. application Ser. No. 11/544,796, filed on Oct. 6, 2006, and claims the benefit of U.S. Provisional Application Ser. No. 61/051,655, filed on May 8, 2008, both of which are incorporated by reference in their entirety.

### FIELD OF INVENTION

This invention relates generally to the detection of a substance, and in one embodiment relates more particularly to an apparatus and method for detecting a substance using a combination of a multi-channeled EC-SPR system with a flow through control system.

### BACKGROUND OF THE INVENTION

Surface Plasmon Resonance (SPR) based apparatuses have been widely used to detect molecules or ions near a metal thin film or bound to the surface of the metal thin film, as well as structural and electronic changes in the analytes induced by molecular interactions, molecule-surface interactions, or by external parameters, such as light and electric fields. The most popular method in SPR detection is to use the Kretechmann configuration, in which the metal film with an appropriate thickness is attached to the prism. Light from a light emitting diode (LED), laser, or other source is incident upon the metal film through the prism, and the reflection is detected and analyzed with a photodetection system. At the resonance angle, the plasmons are excited by the incident light and the intensity of the reflected light drops to a minimum. The resonance angle is extremely sensitive to the refractive index of the liquid medium to which the metal film is exposed. When molecules or ions are present on or near the metal film, the resonance angle changes, and the change is measured from the reflection with an SPR apparatus.

Electrochemical (EC) technique applies an electric potential to an electrode surface and detects the current response, or passes an electric current to the electrode and detects the potential response of the electrode. It can control the surface charge density of the electrode, change the distribution of ions near the electrode surface, initiate an electrochemical reaction on the electrode surface or analytes near or bound to the electrode. The response in the potential or the current is detected. An electrochemical technique typically requires a sample cell to hold an electrolyte or sample solution and two additional electrodes, a reference electrode and a counter electrode, for potential or current control and measurement.

Separation-based analytic methods are tools that separate and detect molecules. Liquid chromatography (LC) and high performance liquid chromatography (HPLC) are among the most popular separation based techniques. Other techniques for separating and detecting molecules include gel electrophoresis, capillary electrophoresis, and related methods.

### BRIEF DESCRIPTION OF THE DRAWINGS

The invention will be better understood from a reading of the following detailed description, taken in conjunction with the accompanying figures in the drawings in which:

FIG. 1 illustrates a diagram representing a first embodiment of the present invention;

FIG. 2 illustrates a schematic view of a portion of the first embodiment of the present invention;

FIG. 3 illustrates a flow chart of a method for detecting a substance in accordance with the first embodiment of the present invention;

FIG. 4 illustrates a diagram of a first configuration of the first embodiment of the present invention;

FIG. 5 illustrates a diagram of a second configuration of the first embodiment of the present invention;

FIG. 6 illustrates a diagram of a third configuration of the first embodiment of the present invention;

FIG. 7 illustrates a diagram of a fourth configuration of the first embodiment of the present invention;

FIG. 8 illustrates a diagram of a fifth configuration of the first embodiment of the present invention;

FIG. 9 illustrates a diagram representing a second embodiment of the present invention;

FIG. 10 illustrates a diagram representing a third embodiment of the present invention;

FIG. 11 illustrates a diagram representing a fourth embodiment of the present invention;

FIG. 12 illustrates a graph of an example of a SPR detection;

FIG. 13 illustrates a graph of an example of an EC detection of an EC-SPR system;

FIG. 14 illustrates a graph of an example of an SPR detection of an EC-SPR system;

FIG. 15 illustrates a diagram of a sixth configuration of the first embodiment of the present invention; and

FIG. 16 illustrates a diagram of a seventh configuration of the first embodiment of the present invention.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

An electrical “coupling” and the like should be broadly understood and include coupling involving any electrical signal, whether a power signal, a data signal, and/or other types or combinations of electrical signals. A mechanical “coupling” and the like should be broadly understood and include mechanical coupling of all types. The absence of the word “removably,” “removable,” and the like near the word “coupled,” and the like does not mean that the coupling, etc. in question is or is not removable.

### DETAILED DESCRIPTION

In embodiments of the present invention, an apparatus for SPR has a flow through control system in combination with a sample cell that has one or more fluidic channels. In addition, the apparatus can have an electrode that is divided into electrically isolated regions that align with the individual fluidic channel, allowing independent potential/current control and electrochemical detection of the individual regions. The flow through control system can be coordinated to pass different sample solutions through the fluidic channels in parallel. The flow through control system can also be used to pass a given sample solution through multiple fluidic channels sequentially. In addition, the flow through control system can include a timing mechanism to coordinate a sequence of electrochemical reactions and electrochemical and/or SPR detections in one or more fluidic channels.

In other embodiments of the present invention, an SPR apparatus has a sensor surface that can be modified with different functional groups, including charged groups that can determine the charge of analytes eluted from separation based techniques. In addition, the system can comprise a control unit to coordinate the operation of the separation techniques with the SPR.

In yet other embodiments of the present invention, SPR may be combined with electrochemical techniques for an EC-SPR system, thus allowing electrochemical and SPR to be operated simultaneously. In addition, one or more multiple separation instruments can be connected to one or more SPR and/or EC-SPR instruments, thus allowing higher throughput and additional functionalities.

In further embodiments, an apparatus for detecting one or more substances can include: (a) a metal film layer; (b) a sample cell having at least one fluidic channel; (c) a flow through control system; (d) a light source; (e) a light detection system; and (f) a control unit.

In other embodiments, a method of detecting one or more fluids can include: (a) injecting one or more fluids into a sample cell; (b) detecting characteristics of the one or more fluids; and (c) controlling the flow of the one or more fluids.

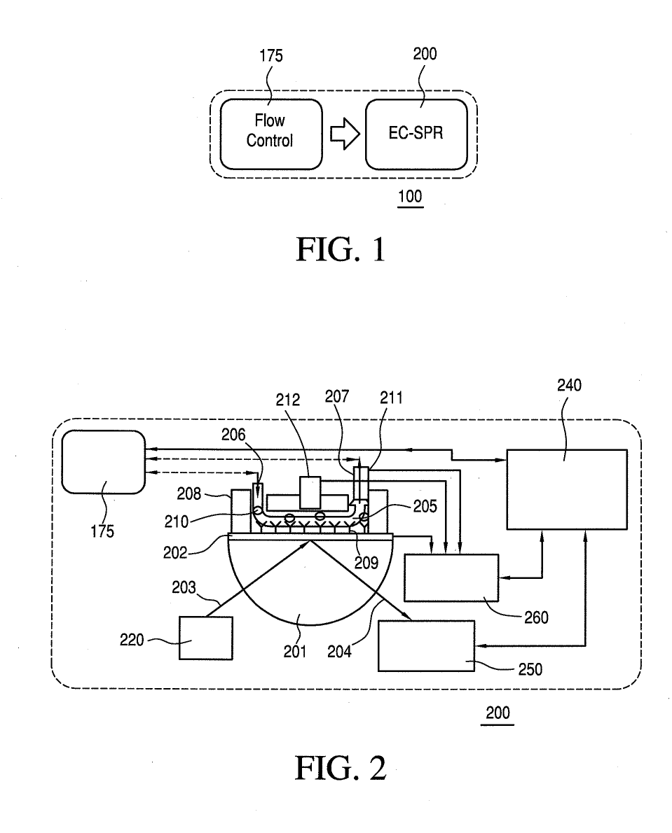

FIG. 1 illustrates a diagram of a first exemplary embodiment of electrochemical SPR (EC-SPR) system 100. EC-SPR system comprises EC-SPR apparatus 200 and flow through control system 175.

FIG. 2 illustrates a schematic view of an EC-SPR apparatus 200. EC-SPR 200 has a metal film layer 202. Metal film layer 202 can include a metal-coated optically transparent slide. Metal film layer 202 is placed on a dielectric body, such as, for example, prism 201 illustrated if FIG. 2. Metal film layer 202 can be one continuous piece, or metal film layer 202 can be divided into multiple regions. Each of these regions can be electrically isolated from each other.

At least a portion of metal film layer 202 is exposed to one or more fluids. A fluid can comprise a number of different fluids, such as, for example, a sample, a buffer solution, and/or a carrier solution. The portion of layer 202 that is exposed to a fluid can be bare, or alternatively, can be coated with molecules 209. Molecules 209 allow selective binding of analytes 210, which are present in the one or more fluids that pass through the fluidic channels of sample cell 208, onto the exposed surface of the metal film layer 202. Analytes 210 can include, for example, molecules, ions, atoms, viruses, bacteria, and/or cells. If metal film layer 202 has been divided into multiple regions, each region can be coated with one or more different molecules. Alternatively, each region can be coated with the same molecule(s). In addition, one region can be bare, while another region is coated with molecule(s).

According to one embodiment, metal film layer 202 can be a single continuous metal film layer. In other embodiments, metal film layer 202 has multiple electrically isolated regions. For example, each electrically isolated region is aligned with a separate fluidic channel. The electrical isolation is beneficial because it assists in the independent control and measurement of the different regions, either electrically or electrochemically. To control the potentials or currents of the working electrodes, reference electrode 212 and counter electrode 211 are used together with a multi-channel potentiostat. Reference electrode 212 can comprise, for example, a silver/silver chloride (Ag/AgCl) reference electrode and can be positioned at or near the center of the fluidic channel of the electrically isolated region in which reference electrode 212 is located, and counter electrode 211 can comprise, for example, glassy carbon, and can be positioned at or near the exit of flow of the fluidic channel of the electrically isolated region in which counter electrode 211 is located. In addition, counter electrode 211 can be positioned above the region of metal layer where surface plasmons are excited and detected. Each electrically isolated region can have a separate counter electrode and a reference electrode. In some examples, there are more than one counter electrode, but only one reference electrode. If there is more than one counter electrode present, the reference electrode can be located equidistant from all counter electrodes.

As an example, a bipotentiostat can be used to control independently the potentials of the regions in two fluidic channels. One channel can be used for electrochemical reaction of analytes 210, which is controlled by applying a potential to the electrode in the region, either at a fixed value or a pulse with a defined duration and amplitude. The reaction can be monitored simultaneously by the electrochemical current and SPR. The reaction products are carried to a downstream fluidic channel and detected using SPR. In a situation in which the reaction products are electrochemically active, such as, for example, redox molecules, the reaction products can also be detected electrochemically on an electrode of the downstream fluidic channel.

In addition, the flow rate of the fluid or fluids can be controlled and varied to obtain kinetic and mechanistic information of the electrochemical reactions. For example, if the reaction products are short lived, a faster flow rate can be used to more quickly move the reaction products to a second fluidic channel to be detected before the reaction products decay into other products.

EC-SPR apparatus 200 comprises sample cell 208. Sample cell 208 has two major portions. The first portion of sample cell 208 can be comprised of a rigid material. In the same or other examples, the first portion of sample cell 208 can comprise fluidic compatible and/or bio-compatible materials. For example, the first portion of sample cell 208 can comprise polyetheretherketone (PEEK). The first portion of sample cell 208 has inlets 206 and outlets 207. In addition, counter electrode 211 and reference electrode 212 can be attached to the first portion of sample cell 208. In some embodiments, reference electrode 212 is placed near the location where fluids exit sample cell 208. Sample cell 208 can also comprise various fixtures that are needed to connect sample cell 208 to metal film layer 202.

The second portion of sample cell 208 can comprise a flexible and chemically inert material. In the same or other examples, the second portion of sample cell 208 can include silicone-based elastomers, such as, for example, polydimethylsiloxane (PDMS). The design of the second portion of sample cell 208 defines the fluidic channels and serves as an interface unit that aligns with inlets 206 and outlets 207 of the first portion of sample cell 208. The second portion of sample cell 208 can be designed for many different situations and can be replaceable. As an example, the fluidic channel(s) can be altered, in both pattern and dimensions (including length, width, and height), for use in different applications.

In addition, EC-SPR apparatus 200 has a radiation source 220. Radiation source 220 projects a light beam or other beam of radiation 203. As an example, light beam 203 can be infrared light, ultra violet light, or visible light. Radiation source 220 can also polarize light beam 203.

Radiation source 220 can also comprise an optical lens assembly (not shown) comprising one or more lenses to project light beam 203 at a specific angle onto metal film layer 202. As an example, the lens assembly can comprise a single cylindrical lens.

Radiation source 220 can also include a second light source (not shown) to project a second light beam or other beam of radiation onto film layer 202. The second light beam can also be polarized.

Light beam 203 is focused onto metal film layer 202. As an example, the shape of light beam 203 can be a line or an elliptical shape. Light beam 203 is directed such that it falls onto the one or more fluidic channels, such as, for example, fluidic channel 205 illustrated in FIG. 2. Light beam 203 can also be directed at multiple fluidic channels. Light beam 203 excites surface plasmons at an interface between metal film layer 202, or one or more individual regions of metal film layer 202, and the fluid(s).

When EC-SPR apparatus 200 has two fluidic channels, the first fluidic channel can be designated as a sample channel, and the second fluidic channel can be designated as the reference channel. On the other hand, each of the two fluidic channels may be designated for different sample fluids. Alternatively, each of the fluidic channels may be designated for replicate measurements of the same sample.

EC-SPR apparatus 200 also has radiation detection system 250. In some embodiments, radiation detection system 250 can be a light detection system. The light beam that is reflected from the fluidic channel(s), reflected light beam 204, is directed to radiation detection system 250. System 250 can include one or more light beam sensors or other radiation detector(s). Preferably, system 250 includes two light beam sensors. The light beam sensors can be identical to each other. The light beam sensors can be photodetectors. Radiation detection system 250 can determine the surface plasmon resonance signals.

EC-SPR apparatus 200 also can include a computer 240. Computer 240 can be configured to receive signals from light detection system 250. These signals can be used by the computer for processing, display, and/or analysis. In addition, computer 240 can be used to control the flow through control system 175 and/or various other aspects of EC-SPR apparatus 200, such as, for example, electrochemical control system 260. Electrochemical control system 260 can control the potential and/or the current of metal film layer 202, or individual regions of metal film layer 202. For example, electrochemical control system 260 can hold potential or current at present values for a preset duration of times; ramp up or down potential or current at a particular rate; start and/or stop potential or current at certain values; modulate the potential or current with certain preset amplitudes and/or frequencies; or combinations thereof. In addition, electrochemical control system 260 can detect current and/or potential from metal film layer 202, or currents and/or potentials from individual regions of metal film layer 202. As an example, current can be caused by polarization, chemical reactions, or other potential induced processes of a fluid or fluids present in a fluidic channel. Examples, of potential induced processes include, for example, electrochemical reactions, deposition, plating, dissolution, stripping, electrostatic interaction, and redox processes. In other embodiments, more than one computer may be used, such as, for example, where one computer collects data from light detection system 250, and a separate computer controls the flow through control system 175 and electrochemical control system 260. If electrochemical system 260 controls the potential of metal film layer 202, then electrochemical system 260 can detect the potential response from metal film layer 202. Similarly, if electrochemical system 260 controls the potential of metal film layer 202, then electrochemical system 260 can also detect the current response of metal film layer 202.

Computer 240 can be programmed a number of different ways to control the flow through control system 175 and EC-SPR apparatus 200. In some embodiments, computer 240 is programmed to control specific aspects of the flow through control system. For example, computer 240 can be preprogrammed to control the speed at which the flow through control system 175 delivers fluid(s) into the fluidic channel(s), when to stop the delivery of fluid(s), how long the fluid(s) stay in any particular channel, and/or the sequence of channel(s) through which the fluid(s) will pass.

In other embodiments, computer 240 can be programmed as a feedback system. In such a system, computer 240 will control the variables of flow through control system 175 as a function of the substances detected by the EC-SPR apparatus 200.

Flow through control system 175 can comprise a variation of pumps, valves, tubing, fittings, and other fluidic control and conditioning units. Flow through control system 175 is used to control the flow of fluids into, through, and out of the fluidic channels of sample cell 208.

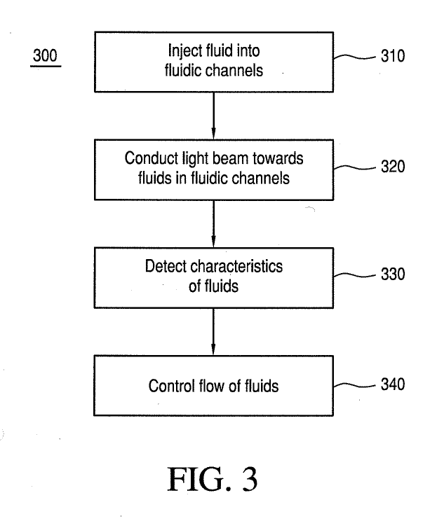

FIG. 3 illustrates a flow chart 300 of a method for detecting one or more substances. Flow chart 300 includes a step 310 for injecting the fluid or fluids into the fluidic channel of the EC-SPR apparatus. As an example, the fluidic channel can be fluidic channel 205 (FIG. 2). In addition, step 310 can also include injecting fluid or fluids into more than one fluidic channel.

Flow chart 300 further includes a step 320 for conducting a beam of light or radiation towards the fluid in the fluidic channel or channels. As an example, radiation source 220 can perform step 320 by projecting a beam of radiation towards the fluidic channel or channels of a sample cell. Also, beam of light or radiation of step 320 can be similar to light beam 203 (FIG. 2), and sample cell of step 320 can be similar to sample cell 208 (FIG. 2).

Flow chart 300 additionally includes a step 330 for detecting the characteristics of the fluid or fluids. As an example, radiation detection system 250 (FIG. 2) can be used to perform step 330. In the same or other examples, electrochemical control system 260 (FIG. 2) can be used to perform step 330 by detecting the current and/or potential in response to an applied potential and/or current, respectively.

In another embodiment, step 330 can also include detecting a surface process in a first fluidic channel and at least one background process in the first fluidic channel. In addition, step 330 can include detecting at least one background process in a second fluidic channel. Then, signals from the first fluidic channel and the second fluidic channel can be compared. The signals from the first fluidic channel and the second fluidic channel can be signals from a radiation detection system or an electrochemical control system. As an example, radiation detection system 250 (FIG. 2) and electrochemical control system 260 (FIG. 2) can be used to perform step 330. Examples of surface processes include: attachment of an analyte to a surface of the metal film layer, detachment of the analyte from the surface of the metal film layer, reaction of the analyte on or near the surface of the metal film layer, conformational change of the analyte on or near the surface of the metal film layer, a change in distribution of the analyte on or near the surface of the metal film layer, an electrochemical reaction, plating, dissolution, stripping, an electrostatic interaction, a redox process, or combinations thereof. Background processes can include any other processes that are not of particular interest to the detection of the analyte, and, in some examples, can include the same types of processes included in the surface processes.

Flow chart 300 also includes a step 340 for controlling the flow of fluid or fluids within the fluidic channel or channels. As an example, flow through control system 175 (FIGS. 1 and 2) can be used to perform step 340.

It should be noted that step 340 can be performed simultaneously with steps 310 and 320. In addition, step 340 can be interchanged in the sequence with any of steps 320 and 330. Also, any of the steps in the sequence can be repeated. It should also be noted that additional steps may be added to method 300. For example, a step for supplying current to a counter electrode and/or reference electrode can be added. In such an example, the counter electrode can be similar to counter electrode 211, and the reference electrode can be similar to reference electrode 212 (both of FIG. 2).

In addition flow chart 300 can also include a step for initializing the flow through control system. As an example, the flow through control system of this step can be flow through control system 175 (FIGS. 1 and 2). Initialization of the flow through control system can be done using a computer, such as, for example, computer 240 (FIG. 2). Initialization of the flow through control system can comprise programming the computer to instruct the control system to enact a specific sequence of steps to control the flow of fluid(s) through an EC-SPR apparatus, such as, for example EC-SPR apparatus 200. Initialization of the flow through control system can also comprise initializing a feedback control loop to control the flow through control system.

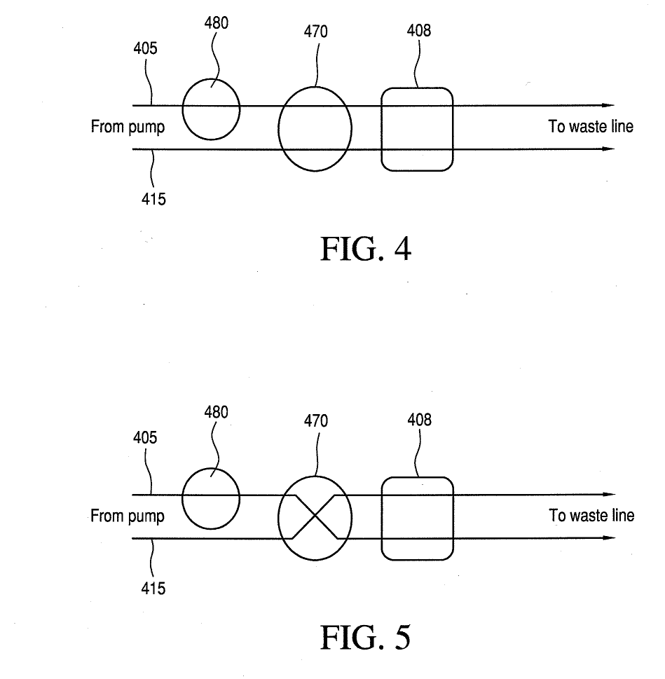

FIGS. 4 and 5 depict diagrams of an example of how flow through control system 175 can operate. As can be seen FIGS. 4 and 5, an EC-SPR system is designed with a sample cell with two fluidic channels. It should also be noted that flow through control system 175 as depicted in FIGS. 4 and 5 also can be used in an SPR system. There is a first fluidic channel 405, and a second fluidic channel 415. A flow through control device 470 determines which fluidic channel through which a particular fluid introduced to the EC-SPR system should pass. Flow through control device 470 can comprise, for example, a valve. In other embodiments, the flow through control device can be a combination of any number of the following: pumps, valves, tubing, fittings, and other fluidic control and conditioning units. Flow through control device 470 is a portion of a flow through control system, such as, for example, flow through control system 175 (FIGS. 1 and 2). In addition, a fluid sample can be added to the EC-SPR system at location 480. After the fluids in fluidic channels 405 and 415 pass through flow through control device 470, the fluids passes onto sample cell 408 where it can be evaluated. As an example, sample cell 408 can be similar to sample cell 208 (FIG. 2). One or more fluid(s) can be moved through channels 405 and 415 via a pump or pumps.

FIG. 4 illustrates an example of the use of a flow through control system in combination with an EC-SPR, where a sample fluid is injected into first fluidic channel 405 at location 480. Second fluidic channel 415 can have a carrier solution within it. Both fluidic channels pass through flow through control device 470. In the example illustrated in FIG. 4, the sample fluid continues on in first fluidic channel 405 and passes onto sample cell 408 where it can be evaluated using EC-SPR. Upon exiting sample cell 408, the fluids in fluidic channels 405 and 415 are moved to a waste line.

FIG. 5 illustrates another example of the use of a flow through control system in combination with an EC-SPR. In the example of FIG. 5, sample fluid is injected into first fluidic channel 405 at location 480. Second fluidic channel 415 can have a carrier solution within it. The two fluidic channels pass through flow through control device 470. Flow through control device 470 directs the sample fluid in first fluidic channel 405 into second fluidic channel 415. Likewise, the sample solution in second fluidic channel 415 is directed into first fluidic channel 405. The sample fluid in second fluidic channel 415 passes onto sample cell 408, where it can be evaluated using EC-SPR. Upon exiting sample cell 408, the fluids in fluidic channels 405 and 415 are moved to a waste line.

The examples in FIGS. 4 and 5 can also be combined. For example, a sample fluid may pass through flow through control device 470 into first fluidic channel 405 to be evaluated by the EC-SPR system, as demonstrated in FIG. 4. After being evaluated by the system, fluid control device 470 may direct more of the sample fluid into second fluidic channel 415 to be evaluated by the EC-SPR system, as illustrated in FIG. 5. In addition, flow through control device 470 can also direct sample fluid into both fluidic chambers 405 and 415 simultaneously.

In addition, the EC-SPR system can be configured such that the region of the metal film layer through which the channels pass can be coated with different molecules from one another. As an example, the metal film layer can be similar to metal film layer 202 (FIG. 2), and the molecules can be similar to molecules 209. Since, different molecules bind to analytes differently, further substance detection can take place by using two different fluidic channels.

In yet another example, fluidic channels 405 and 415 can have the same set up, i.e., be coated with the same material, or with no material. This configuration would allow the EC-SPR to repeat the same measurements for the sample fluid in two different channels.

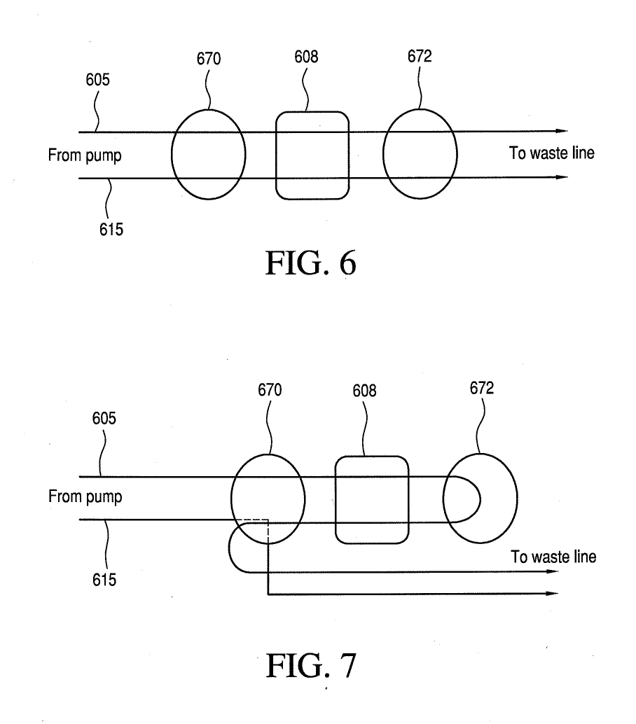

FIGS. 6 and 7 illustrate another example of how flow through control system 175 can be operated. In the example of FIGS. 6 and 7, a sample fluid can be introduced to a fluidic channel where it will be evaluated using EC-SPR. After that evaluation, the fluid can be moved to a waste line, or the fluid can be moved to a second fluidic channel.

FIG. 6 includes first fluidic channel 605, second fluidic channel 615, sample cell 608, first flow through control device 670, and second flow through control device 672. Each of first flow through control device 670 and second flow through control device 672 can be different portions of a single flow through control system, such as, for example flow through control system 175 (FIGS. 1 and 2). As an example, sample cell 608 can be similar to sample cell 208 (FIG. 2) and sample cell 408 (FIGS. 4 and 5).

A sample fluid can be injected into first fluidic channel 605, which passes through first flow through control device 670. First flow through control device 670 maintains the sample fluid in first fluidic channel 605. The sample fluid passes and is evaluated in sample cell 608. After passing through sample cell 608, the sample fluid is moved through second flow through control device 672 to a waste line. In addition, a carrier solution can be injected into second fluidic channel 615, carried through sample cell 608, and passed into the waste line. In another example, a second sample fluid can be injected into second fluidic channel 615, which passes through first flow through control device 670. First flow through control device 670 maintains the second sample fluid in second fluidic channel 615. The second sample fluid passes and is evaluated in sample cell 608. After passing through sample cell 608, the second sample fluid is moved through second flow through control device 672 to a waste line. In some examples, the second sample fluid is the same fluid as the sample fluid. In other examples, the second sample fluid is a different fluid than the sample fluid.

FIG. 7. like FIG. 6, includes first fluidic channel 605, second fluidic channel 615, sample cell 608, first flow through control device 670, and second flow through control device 672. A sample fluid can be injected into first fluidic channel 605. First flow through control device 670 maintains the sample fluid in first fluidic channel 605. The sample fluid is evaluated in sample cell 608. After passing through sample cell 608, second flow through control device 672 directs the sample fluid to pass into second fluidic channel 615, where it is once again evaluated in sample cell 608. After passing through sample cell 608 in second fluidic channel 615, first flow through control device 670 can direct the sample fluid into a waste line. A carrier solution can be injected into second fluidic channel 615. First flow through control device 670 can then direct the carrier solution to the waste line. The example illustrated in FIG. 7 can be useful for studying electrochemical reactions. For example, reactions may take place later in time after exiting first fluidic channel 605, but can be examined when the sample fluid is moved to second fluidic channel 615. In a different embodiment, the metal film in the two channels can be coated with different molecule(s), and the second reaction in the second channel might occur only after the first reaction in the first channel occurs. In the same or different embodiments, the flow rate of the sample fluid can be adjusted in first fluidic channel 605 and/or second fluidic channel 615. The flow rate can be adjusted, for example, to allow more time for any reactions to occur. In addition, the flow rate can be stopped, thereby increasing the residence time of the sample fluid in first fluidic channel 605 and/or second fluidic channel 615, thus allowing more time for reactions to occur within the sample fluid.

In the example of FIG. 6, a carrier solution can be introduced to second fluidic channel 615. Second fluidic channel 615 could serve as a reference for reducing noise and drift. In the example of FIG. 7, a carrier solution can be introduced into second fluidic channel 615 while the sample solution is in first fluidic channel 605. When second flow through control device 672 directs the sample fluid into second fluidic channel 615, the carrier solution can be passed to a waste line without being mixed with the sample fluid. In one embodiment, first flow through control device 670 and second flow through control device 672 can be the same device. In other words, a single device controls the channel selection before and after a fluid enters into sample cell 608. In addition, it is possible to have more than two fluid control devices that accomplish the examples of FIGS. 6 and 7.

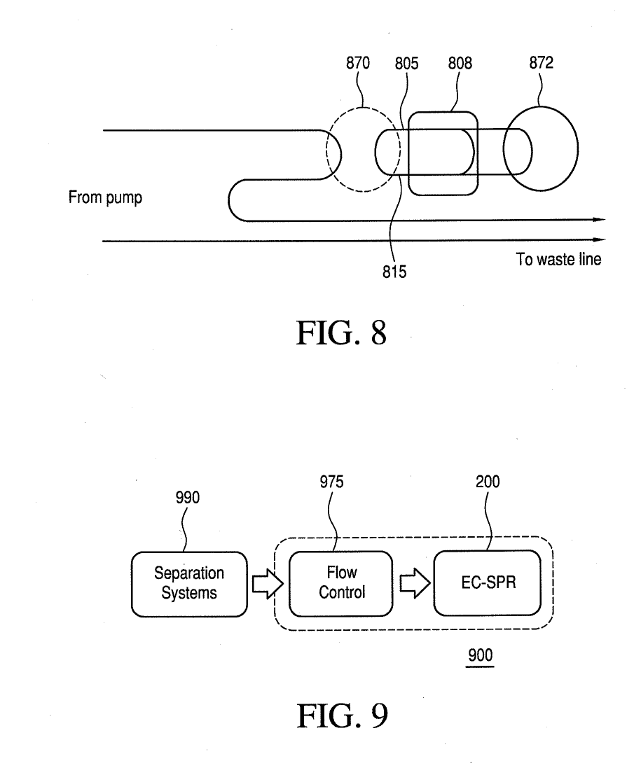

Another example of the use of flow through control system 175 is illustrated in FIG. 8. In the example of FIG. 8, a sample fluid can be passed through two fluidic channels sequentially for an arbitrary number of times. The example of FIG. 8 includes first fluidic channel 805, second fluidic channel 815, sample cell 808, first flow through control device 870, and second flow through control device 872. A sample fluid can be injected into first fluidic channel 805. First flow through control device 870 maintains the sample fluid in first fluidic channel 805. The sample fluid is evaluated in sample cell 808. After passing through sample cell 808, second flow through control device 872 directs the sample fluid to pass into second fluidic channel 815, where it is once again evaluated in sample cell 808. After being evaluated in sample cell 808, the sample fluid can once again be transferred to first fluidic channel 805 by first flow control device 870. In some embodiments, the process can be repeated one or more times through first and second fluidic channels 805 and 815, with the sample fluid eventually being transferred to the waste line. In particular, the sample fluid can be transferred to the waste line from first fluidic channel 805 or second fluidic channel 815.

In some examples, the flow rate of the sample fluid can be altered while in first fluidic channel 805 and/or second fluidic channel 815. As an example, the sample fluid flow can be stopped in first fluidic channel 805 and/or second fluidic channel 815. Then, the fluid flow of sample fluid can be started again. The amount of time that the flow rate is stopped can also be varied. In other examples, the flow rate of the sample fluid can be increased and/or decreased while in first fluid channel 805 and/or second fluidic channel 815. In further examples, the sample fluid can be heated, cooled, and/or pressurized before entering, or while located in, any of first or second fluidic channels 805 or 815. Moreover, before the sample fluid enters, or while it is located in, any of first or second fluidic channels 805 or 815, a catalyst, chemical, or other additive can be added to the sample fluid.

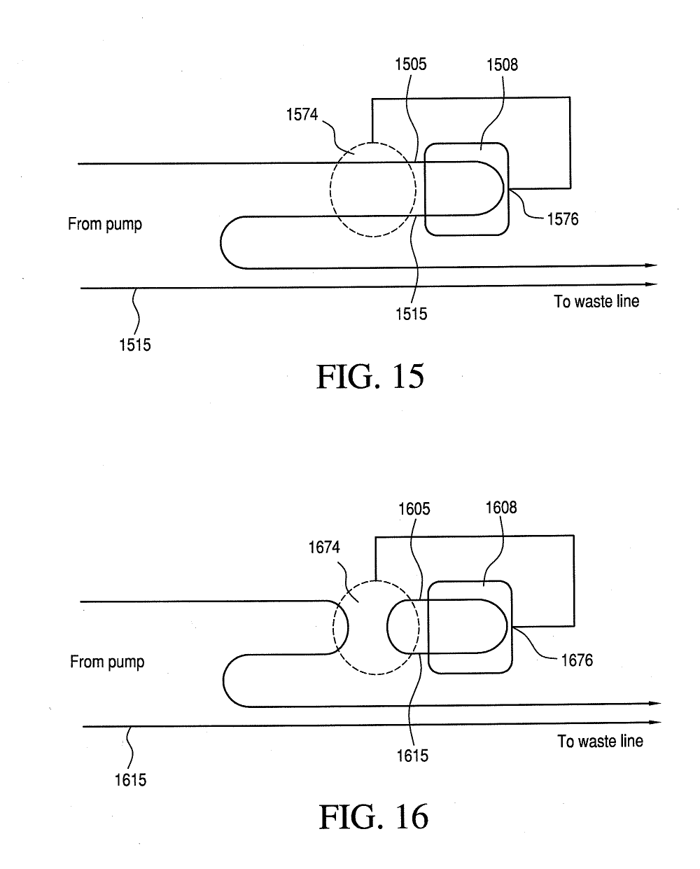

It should also be noted that first flow through control device 870 and second flow through control device 872 can be the same device, that is to say that a single device controls the channel selection before and after a fluid enters into sample cell 808. In addition, it is possible to have more than two fluid control devices that accomplish the examples of FIG. 4-8. For example, FIGS. 15 and 16 illustrate examples of the use of flow through control system 175 when there is a single flow through control device.

FIG. 15 includes first fluidic channel 1505, second fluidic channel 1515, sample cell 1508, and flow though control device 1574. A sample fluid is injected into first fluidic channel 1505. Flow though control device 1574 maintains the sample fluid in first fluidic channel 1505. The sample fluid is evaluated in sample cell 1508. Flow through control device 1574 directs the sample fluid to pass into second fluidic channel 1515, where it can once again be evaluated in sample cell 1508. Flow through control device 1574 directs the sample fluid into second fluidic channel 1515 via portion 1576 of flow through control device 1574. Portion 1576 can comprise one or more tubings, valves, fittings, pumps, or combinations thereof. In some examples, a fluidic channel, such as, for example, second fluidic channel 1515, can direct a fluid, such as, for example, a carrier solution, directly to the waste line after the fluid is injected into the fluidic channel.

FIG. 16 includes a first fluidic channel 1605, second fluidic channel 1615, sample cell 1608, and flow through control device 1674. A sample fluid is injected into first fluidic channel 1605. Flow through control device 1674 maintains the sample fluid in first fluidic channel 1605. The sample fluid is evaluated in sample cell 1608. After passing through sample cell 1608, flow through control device 1674 directs the sample fluid to pass into second fluidic channel 1615. Flow through control device 1674 directs the sample fluid into second fluidic channel 1615, where the sample fluid is evaluated again in sample cell 1608, via portion 1676 of flow through control device 1674. Portion 1676 can comprise one or more tubings, valves, fittings, pumps, or combinations thereof. After being evaluated in sample cell 1608, the sample fluid can once again be transferred to first fluidic channel 1605 by flow through control device 1674. The sample fluid can be directed between first fluidic channel 1605 and second fluidic channel 1615 any number of times. In some examples, a fluidic channel, such as, for example, second fluidic channel 1615, can direct a fluid, such as, for example, a carrier solution, directly to the waste line after the fluid is injected into the fluidic channel. The other variations described with reference to FIG. 8 can also apply to the embodiments of FIGS. 15 and/or 16.

The examples of FIGS. 4-8 have been shown with only two fluidic channels each. Each of these configurations can be configured to have more than two fluidic channels. When there are more than two fluidic channels present, the flow through control system can either pass a sample fluid through one single selected fluidic channel at a time, or pass a number of different sample solutions through multiple fluidic channels in parallel. In addition, a sample fluid can pass through each fluidic channel sequentially, or it may pass through a sequence of particular fluidic channels, while the flow through control system passes different samples through the remaining fluidic channels in parallel. In addition, a sample fluid can be re-circulated through any number of fluidic channels.

The flow through control system examples of FIGS. 4-8 also can control the flow of sample fluids in a variety of other ways. For example, additional control of the flow can be achieved using a variety of flow rates, residence times, and sample cells with different fluidic channel pathways, and different fluidic channel heights and widths.

FIG. 9 illustrates a diagram of a second exemplary embodiment of electrochemical SPR (EC-SPR) system 900. Similar to the embodiment of FIG. 1, EC-SPR system comprises EC-SPR apparatus 200 and flow through control system 975. In addition, system 900 includes a separation system 990. Separation system 990 can include one or more separation-based instruments, such as, for example, liquid chromatography, high performance liquid chromatography, ultra high performance liquid chromatography, capillary electrophoresis, gel electrophoresis, isoelectric electrophoresis, or isotachophoresis. Separation system 990 can divide a sample solution into multiple components. The components of the separated sample solution, such as, for example, multiple solutions, molecules, and/or analytes, from separation system 990 can be directed into EC-SPR apparatus 200. For example, the outlet or outlets of separation system 990 can be connected to the inlet or inlets, such as, for example, inlet 206, of sample cell 208 in FIG. 2. EC-SPR apparatus 200 and flow through control system 975 are used as detection units for the samples produced from separation system 900, or they can be used to provide additional analysis of the samples that is not possible in separation system 900 alone. As an example, flow through control system 975 can be similar to flow through control system 175 and can be configured similar to the examples of FIGS. 4-8.

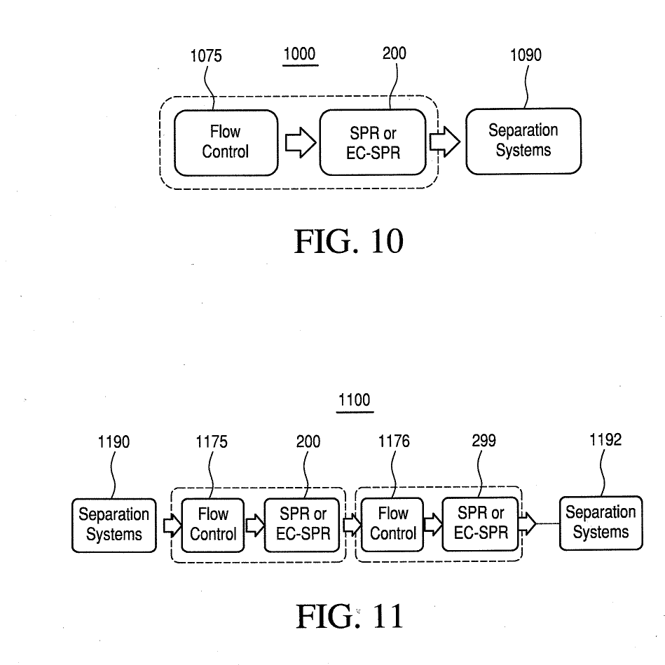

A third embodiment of the present invention is illustrated in FIG. 10. System 1000 has flow through control system 1075, EC-SPR apparatus 200, and separation system 1090. Flow through control system 1075 can be similar to flow through control system 175 (FIGS. 1 and 2) and flow through control system 975 (FIG. 9) and can be configured similarly to the examples of FIGS. 4-8. In the embodiment of FIG. 10, fluids that pass out of EC-SPR apparatus 200 pass through separation system 1090. For example, the outlet or outlets of sample cell 208 (FIG. 2), such as, for example, outlet 207 (FIG. 2), can be connected to the inlet or inlets of separation system 1090. As an example, separation system 1090 can be similar to separation system 990 (FIG. 9).

A fourth embodiment of the present invention is illustrated in the diagram of FIG. 11. The embodiment of FIG. 11 has a first separation system 1190, a second separation system 1192 and any number of flow control systems and EC-SPR apparatuses. As an example, the diagram of FIG. 11 illustrates a system 1100 with first separation system 1190 that separates a sample into one or more fluids. A first flow through control system 1175 feeds the fluids into first EC-SPR apparatus 200. The resulting fluids are controlled by second flow through control system 1176 as the fluid enters second EC-SPR apparatus 299, which can be similar to first EC-SPR apparatus 200. In addition, first EC-SPR 200 can be different from second EC-SPR 299. For example, the two EC-SPR apparatuses can be configured to have different electric bias, or different metal film layers. Thus, first EC-SPR apparatus 200 can perform a different analysis than second EC-SPR apparatus 299. The resulting fluids are entered into second separation system 1192 whereby the fluids are separated. As an example, first flow through control system 1175 and second flow through control system 1176 can be similar to one or more of flow through control system 175 (FIGS. 1 and 2), flow through control system 975 (FIG. 9), and flow through control system 1075 (FIG. 10) and can be configured similar to the examples of FIGS. 4-8. First separation system 1190 and second separation system 1192 can be similar to one or more of separation system 990 (FIG. 9) and separation system 1090 (FIG. 10). Any number of iterations of flow through control systems and EC-SPR apparatuses can be used. Furthermore, there can be more than two flow through control systems and/or EC-SPR apparatuses. For example, system 1100 can have three or more EC-SPR apparatuses with three or more corresponding flow through control systems.

In addition, the embodiments of FIG. 9-11 can have a unified control system. The unified control system can control one or more flow through control systems, one or more separation system, and one or more EC-SPR apparatus. For example, the unified control system can control separation systems 990 (FIG. 9), 1090 (FIG. 10), and 1190 and 1192 (FIG. 11); flow through controls systems 975 (FIG. 9), 1075 (FIG. 10), and 1175 and 1176 (FIG. 11); and EC-SPR apparatuses 200 (FIGS. 9, 10, and 11) and 299 (FIG. 11). The unified control system can coordinate the control of the various systems and apparatuses. For example, the unified control system can be pre-programmed to control the separation systems, flow through control systems, and EC-SPR apparatuses present in the overall system setup. In other examples, the unified control system can be a real time feedback control system. For example, the unified control system can be programmed to control the flow of fluid within the system based on the measurements received from one or more EC-SPR apparatuses present in the system. In the same or different examples, the separation system(s) of the system can be controlled based on the measurements received by one or more EC-SPR apparatuses present in the system. In some embodiments the unified control system is a computer. As an example, the unified control system can be similar to computer 240 (FIG. 2).

It should be noted that any of the aforementioned EC-SPR apparatuses can be a SPR-only apparatus, i.e., with no electrochemical component. For example, EC-SPR apparatus 200 can be an SPR-only apparatus.

### Examples

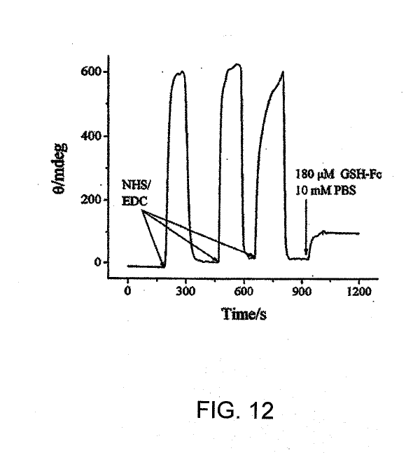

FIG. 12 shows an exemplary sensorgram of a sample according to the exemplary embodiments of the present invention. The example of FIG. 12 illustrates chemical activation of a polyethylene glycol (PEG) self-assembled monolayer with N-hydrosuccinimide (NHS) and N-ethyl-N′-(3-dimethylaminopropyl)-carbodiimide (EDC) and the following attachment of the ferrocene-tagged glutathione (GSH-Fc) analyte molecules in an EC-SPR flow cell. The surface of the sample sell of the EC-SPR was activated by injecting the NHS/EDC mixture solution in three injections (the first three peaks of the sensorgram), and GSH-Fc can be readily attached in one injection. The running buffer used was phosphate-buffered saline solution.

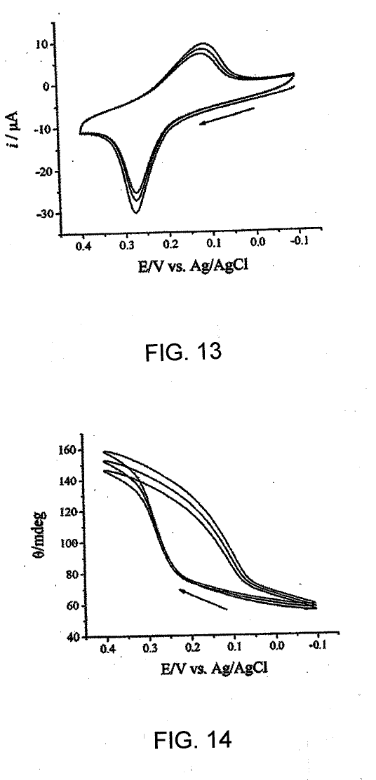

FIGS. 13 and 14 show additional exemplary graphs according to exemplary embodiments of the present invention. FIG. 13 shows the EC portion, and FIG. 14 shows the SPR portion of an EC-SPR detection of GSH-Fc oxidation/reduction reactions simultaneously acquired after the GSH-Fc immobilization (from the example of FIG. 12). Three voltammetric cycles were implemented at a scan rate of 50 millivolts per second (mV/s). The phosphate buffered saline solution was replaced with potassium perchlorate solution with the flow control system. The arrows in FIGS. 13 and 14 represent the scan directions.

Although the invention has been described with reference to specific embodiments, it will be understood by those skilled in the art that various changes can be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the methods discussed herein may be implemented in a variety of embodiments, and that the foregoing discussion of certain of these embodiments does not necessarily represent a complete description of all possible embodiments. Accordingly, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. An apparatus for detecting one or more substances comprising:
a dielectric body;
a layer coupled to a surface of the dielectric body;
wherein layer comprises metal;
a sample cell;
wherein the sample cell comprises:
at least one fluidic channel;
a flow through control system;
an electrochemical system;
a light source;
wherein the light source excites surface plasmons at an interface between the layer and one or more fluids in contact with the layer;
a light detection system; and
a control unit.

2. The apparatus of claim 1, wherein:
the electrochemical system controls a potential of at least a portion of the layer and detects a current from the at least a portion of the layer.

3. The apparatus of claim 1, wherein:
the electrochemical system controls a current of at least a portion of the layer and detects a potential from the at least a portion of the layer.

4. The apparatus of claim 1, wherein:
the layer is a single electrically continuous piece.

5. The apparatus of claim 1, wherein:
the layer is divided into more than one electrically isolated region.

6. The apparatus of claim 1, wherein:
the layer is coated with molecules.

7. The apparatus of claim 1, wherein:
the flow control system comprises at least one of: a valve, a pump, a tubing, a fitting, or combinations thereof.

8. The apparatus of claim 1, wherein:
the control unit comprises a computer that is adapted to control at least one of:
the flow control system, the electrochemical system, the light detection system, or combinations thereof.

9. The apparatus of claim 1, wherein:
the sample cell further comprises:
a first portion; and
a second portion;
wherein:
the first portion of the sample cell comprises a rigid material; and
the second portion of the sample cell comprises a flexible material;
the flexible material is chemically inert; and
the second portion of the sample cell comprises the at least one fluidic channel.

10. The apparatus of claim 9, wherein:
the sample cell further comprises at least one counter electrode and a reference electrode.

11. The apparatus of claim 10, wherein:
the at least one counter electrode is positioned in the at least one fluidic channel and above a region of the layer where the surface plasmons are excited.

12. The apparatus of claim 10, wherein:
the reference electrode is positioned near an exit of the at least one fluidic channel.

13. The apparatus of claim 1, further comprising:
a separation system.

14. The apparatus of claim 13, wherein:
the separation system comprises at least one of the following: a liquid chromatography unit; a high performance liquid chromatography unit; an ultra high performance liquid chromatography unit; a capillary electrophoresis unit; a gel electrophoresis unit; an isoelectric electrophoresis unit; or an isotachophoresis unit.

15. A method of detecting one or more fluids comprising:
injecting the one or more fluids into a sample cell;
exposing the one or more fluids to at least a portion of a metal film layer;
directing a beam of radiation towards the one or more fluids in the sample cell;
exciting surface plasmons at an interface of the metal film layer and the one or more fluids;
reflecting the beam of radiation off of the metal film layer;
detecting the beam of radiation reflected off of the metal film layer;
electrically biasing at least a portion of the metal film layer with respect to a reference electrode exposed to the one or more fluids; and
controlling the flow of the one or more fluids.

16. The method of claim 15; wherein:
detecting the beam of radiation comprises determining surface plasmon resonance signals.

17. The method of claim 15, wherein:
the one or more fluids comprise at least one of the following: an analyte, a buffer solution, or combinations thereof.

18. The method of claim 15, wherein:
controlling the flow comprises at least one of the following: starting flow of the one or more fluids; stopping the flow of the one or more fluids; changing the direction of the flow of the one or more fluids; changing a flow rate of the one or more fluids; selecting a first fluidic channel of the sample cell in which to flow the one or more fluids; selecting a second fluidic channel of the sample cell in which to flow the one or more fluids; switching the flow of the one or more fluids from the first fluidic channel to the second fluidic channel; switching the flow of the one or more fluids from the second fluidic channel to the first fluidic channel; heating the one or more fluids; cooling the one or more fluids; pressurizing the one or more fluids; or
combinations thereof.

19. The method of claim 15, wherein:
controlling the flow of the one or more fluids comprises at least one of the following: directing the one or more fluids in a first fluidic channel of the sample cell; directing the one or more fluids through the first fluidic channel and a second fluidic channel of the sample cell at the same time; directing the one or more fluids through the first fluidic channel and the second fluidic channel in series; circulating the one or more fluids between the first fluidic channel and the second fluidic channel; or combinations thereof.

20. The method of claim 15, wherein:
controlling the flow of the one or more fluids comprises preprogramming an automated flow through control system to direct the flow of the one or more fluids into and out of at least one fluidic channel.

21. The method of claim 15, wherein:
controlling the flow of the one or more fluids comprises programming an automated flow through control system to use feedback control to direct the flow of the one or more fluids into and out of at least one fluidic channel.

22. The method of claim 15, wherein:
electrically biasing the at least a portion of the metal film layer comprises:
biasing the at least a portion of the metal film layer with a potential; and
detecting a current of the at least a portion of the metal film layer.

23. The method of claim 22, wherein:
biasing the at least a portion of the metal film layer comprises at least one of:
holding the potential at a first preset value for a duration of time while the one or more fluids is located in the sample cell;
ramping up or down the potential at a preset rate while the one or more fluids is located in the sample cell;
biasing the at least a portion of the metal film layer at one or more preset potential values and unbiasing the at least a portion of the metal film layer, while the one or more fluids are located in the sample cell;
while the one or more fluids is located in the sample cell, modulating the potential with one of:
a preset amplitude;
a preset frequency; or
combinations thereof; or
combinations thereof.

24. The method of claim 15, wherein:
electrically biasing the at least a portion of the metal film layer comprises:
biasing the at least a portion of the metal film layer with a current; and
detecting a potential of the at least a portion of the metal film layer.

25. The method of claim 24, wherein:
biasing the at least a portion of the metal film layer comprises at least one of:
holding the current at a first preset value for a duration of time while the one or more fluids is located in the sample cell;
ramping up or down the current at a preset rate while the one or more fluids is located in the sample cell;
biasing the at least a portion of the metal film layer at one or more preset current values and unbiasing the at least a portion of the metal film layer, while the one or more fluids are located in the sample cell;
while the one or more fluids are located in the sample cell, modulating the current with one of:
a preset amplitude;
a preset frequency; or
combinations thereof; or
combinations thereof.

26. The method of claim 15, further comprising:
detecting a surface process and at least one first background process in a first fluidic channel of the sample cell;
detecting at least one second background process in a second fluidic channel of the sample cell; and
comparing a signal from the first fluidic channel of the sample cell with a signal from second fluidic channel of the sample cell.

27. The method of claim 26, wherein:
the surface process comprises at least one of the following: attachment of an analyte to a surface of the metal film layer; detachment of the analyte from the surface of the metal film layer; reaction of the analyte on or near the surface of the metal film layer; conformational change of the analyte on or near the surface of the metal film layer; a change in distribution of the analyte on or near the surface of the metal film layer; an electrochemical reaction; plating;
dissolution; stripping; an electrostatic interaction; a redox process; or combinations thereof.

28. The method of claim 15, wherein:
electrically biasing at least a portion of the metal film layer comprises:
facilitating a surface process in a first fluidic channel of the sample cell; and
further comprising:
directing a product of the surface process to a second fluidic channel of the sample cell; and
detecting the product of the surface process.

29. The method of claim 15, further comprising:
separating the one or more fluids into more than one component.

30. The method of claim 28, wherein:
separating the one or more fluids comprises using at least one of the following: liquid chromatography; high performance liquid chromatography; ultra high performance liquid chromatography; capillary electrophoresis; gel electrophoresis; isoelectric electrophoresis; or isotachophoresis.

31. The method of claim 29, wherein:
separating the one or more fluids occurs prior to injecting the one or more fluids into the sample cell.

32. The method of claim 28, further comprising:
moving the one or more fluids out of the sample cell;
wherein the separating the one or more fluids occurs after moving the one or more fluids out of the sample cell.
